(19) United States
(12) Patent Application Publication
(10) Pub. No.: US 2010/0123393 A1
(43) Pub. Date: May 20, 2010

(54) HID LAMP WITH A CANTED ARC TUBE

(75) Inventors: Junming Tu, Bath, NY (US); John Conrad, Bath, NY (US); William Solsky, Bath, NY (US); Dan Shumway, Watkins Glen, NY (US); William Henry Hitchcock, Campbell, NY (US); William Neil Ives, Hornell, NY (US); Kevin Provagna, Medina, OH (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/273,767

(22) Filed: Nov. 19, 2008

(51) Int. Cl. H01J 61/02

(52) U.S. Cl. 313/621

(57) ABSTRACT

An HID lamp with a canted arc tube including a high intensity discharge (HID) lamp with an outer envelope (1) having a neck portion (34) and a lamp axis (32); a frame (9) having first frame section (9a), second frame section (9b), third frame section (9c), the first frame section (9a) being pivotably connected to the second frame section (9b) in a first connection, and the second frame section (9b) being pivotably connected to the third frame section (9c) in a second connection; and an arc tube (4) having an arc tube axis (33) attached to the second frame section (9b). At least one of the first connection and the second connection is a deformable connector (130, 132) paired with a rotary joint (21, 23); and the arc tube axis (33) forms a predetermined angle with the lamp axis (32) when the frame (9) is in a final configuration.

The technical field of this disclosure is high intensity discharge (HID) lamps, particularly, an HID lamp with a canted arc tube.

In the majority of HID lamps, the arc tube is arranged in the outer envelope aligned with the lamp axis. The outer envelope has a bulbous portion surrounding the arc tube, and an elongate neck portion extending from the bulbous portion. The arc tube is normally supported in the lamp envelope by a support frame fixed to rigid current-supply conductors extending from the lamp stem through the neck portion of the outer envelope.

The burning orientation of the arc tube in HID lamps affects the efficiency of the lamps. It has been found that a vertical burning position of the arc tube is most efficient, followed by a horizontal burning position. However, in certain lamp applications, it is not practicable to orient the outer bulb in a horizontal or vertical position. For example, in portable light towers for illuminating sports playing fields, the design and position of the reflector for illuminating the playing field limits the orientation of the outer bulb to a base-up orientation with the bulb axis between the vertical and horizontal. Thus, such luminaires would support the arc tube at an angle which is less efficient than the preferred vertical or horizontal burning positions. As a result, prior art lamps having an arc tube aligned with the lamp axis do not provide optimum light distribution or efficiency when operated in such luminaires.

One solution has been to provide a lamp in which the arc tube is supported in the outer envelope at a predetermined angle with respect to the lamp axis. For sports lighting applications, the arc tube is canted such that it would be in a horizontal burning position when secured in a luminaire. However, in lamps having an arc tube canted more than only a few degrees from the lamp axis, the configuration of the frame for supporting the arc tube has prevented the insertion of the frame and arc tube through the elongate neck portion of the standard bulged-tube (BT) outer envelope.

The present generation of HID lamps with canted arc tubes requires complex configurations and/or assembly methods. One approach has been to sever the elongate neck portion from the outer envelope, insert the arc tube assembly into the outer envelope, and reattach the elongate neck portion to the outer envelope. This adds steps to and increases the complexity of the assembly process. Another approach has been to provide rotary joints in an articulated frame holding the arc tube, so that the arc tube assembly is in a generally linear configuration when inserted through the elongate neck portion into the outer envelope. Once in the outer envelope, the articulated portions of the frame are rotated at the rotary joints to achieve the canted arc tube, and locking the rotary joints are locked in place. Unfortunately, the rotary joints present a number of problems. The rotary joints increase the resistance of the frame, reducing lamp efficiency. A shunt strap may be required in parallel with the rotary joint to assure sufficient current carrying capacity. Installation of the rotary joints and shunt straps in the frame increases the number of fabrication steps, increasing costs. Rotary joints can also increase the rejection rate for defective lamps, since the rotary joint may not lock properly. The rotary joints also increase the number of parts that must be stocked and handled.

It would be desirable to have an HID lamp with a canted arc tube that would overcome the above disadvantages.

One aspect of the present invention provides a high intensity discharge (HID) lamp including an outer envelope having a neck portion and a lamp axis; a frame having a first frame section, a second frame section, a third frame section, the first frame section being pivotably connected to the second frame section in a first connection, and the second frame section being pivotably connected to the third frame section in a second connection; and an arc tube having an arc tube axis, the arc tube being attached to the second frame section. At least one of the first connection and the second connection is a deformable connector paired with a rotary joint; and the arc tube axis forms a predetermined angle with the lamp axis when the frame is in a final configuration in the outer envelope.

Another aspect of the present invention provides a high intensity discharge (HID) lamp including an outer envelope having a neck portion and a lamp axis; a frame having a first frame section, a second frame section, a third frame section, a first pair of rotary joints pivotably connecting the first frame section and the second frame section, a second pair of rotary joints pivotably connecting the second frame section and the third frame section; and an arc tube having an arc tube axis, the arc tube being attached to the frame between the first pair of rotary joints and the second pair of rotary joints. The first pair of rotary joints and the second pair of rotary joints are selected from the group consisting of one piece rotary joints, pinned rotary joints, and tabbed rotary joints; and the arc tube axis forms a predetermined angle with the lamp axis when the frame is in a final configuration in the outer envelope.

Another aspect of the present invention provides a high intensity discharge lamp including an outer envelope having a neck portion and a lamp axis; a fixed frame having a first bend and a second bend opposite the first bend; and an arc tube having an arc tube axis, the arc tube being attached to the fixed frame between the first bend and the second bend. The fixed frame is so dimensioned as to be insertable through the neck portion; and the arc tube axis forms a predetermined angle with the lamp axis when the fixed frame is in a final configuration in the outer envelope.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

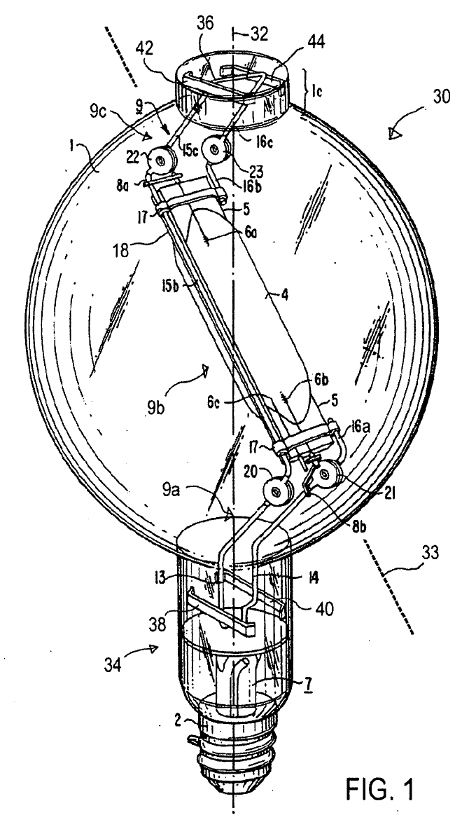

FIG. 1 is a perspective view of an HID lamp with a canted arc tube according to the present invention;

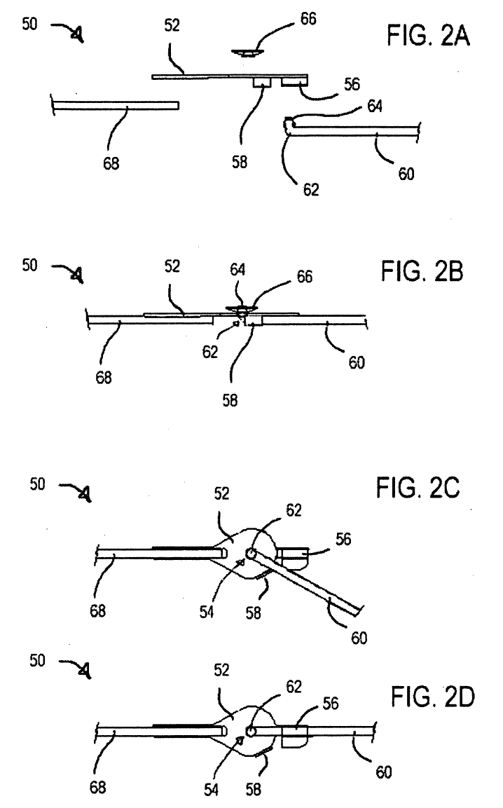

FIGS. 2A-2D are exploded, bottom, side unlocked, and side locked views of a rotary joint for an HID lamp with a canted arc tube according to the present invention;

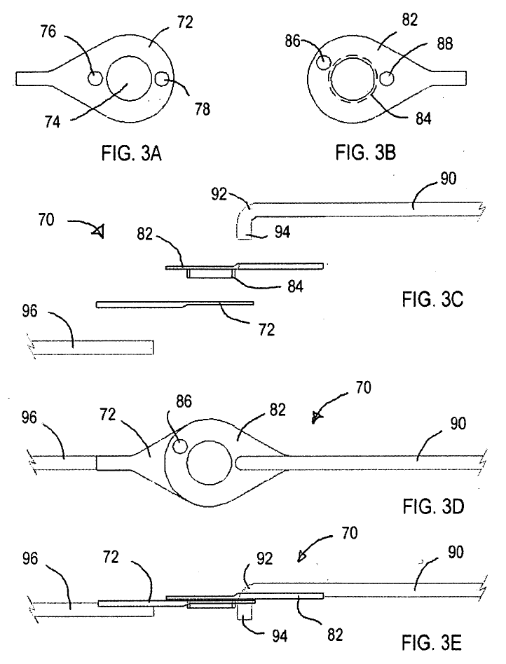

FIGS. 3A-3E are first part side, second part side, bottom exploded, side locked and bottom locked views of another rotary joint for an HID lamp with a canted arc tube according to the present invention;

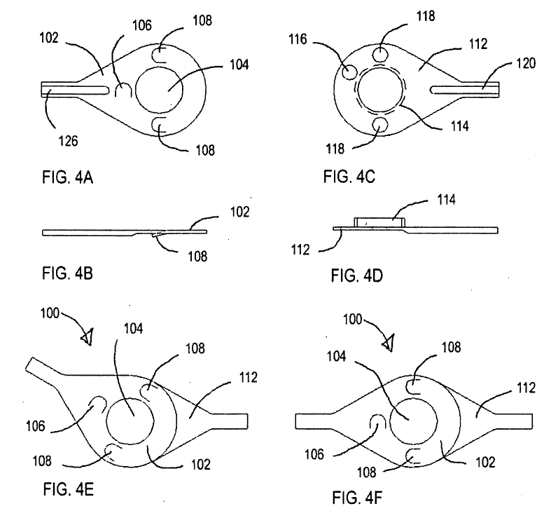

FIG. 4A-4F are first part side, first part bottom, second part side, second part bottom, side unlocked, and side locked views of another rotary joint for an HID lamp with a canted arc tube according to the present invention;

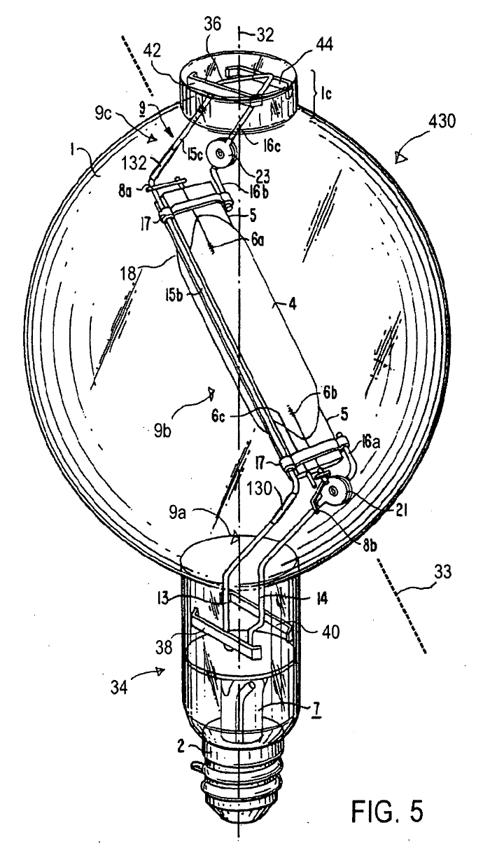

FIG. 5 is a perspective view of another HID lamp with a canted arc tube according to the present invention;

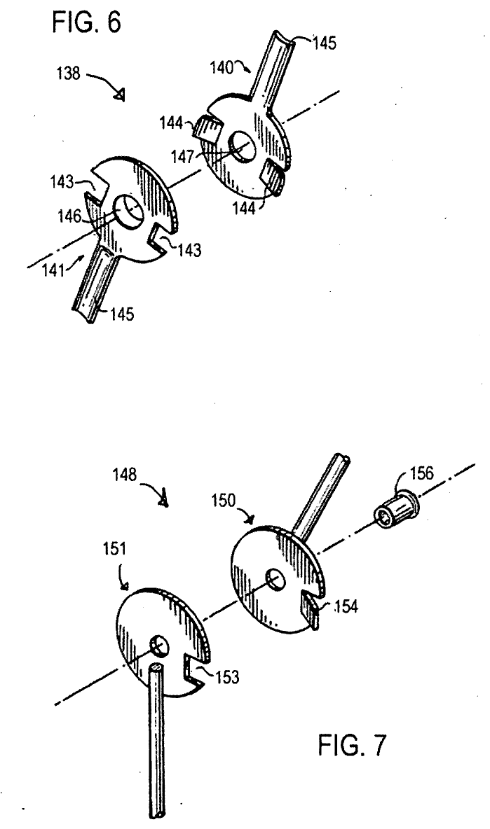

FIG. 6 is an exploded view of another rotary joint for an HID lamp with a canted arc tube according to the present invention;

FIG. 7 is an exploded view of another rotary joint for an HID lamp with a canted arc tube according to the present invention;

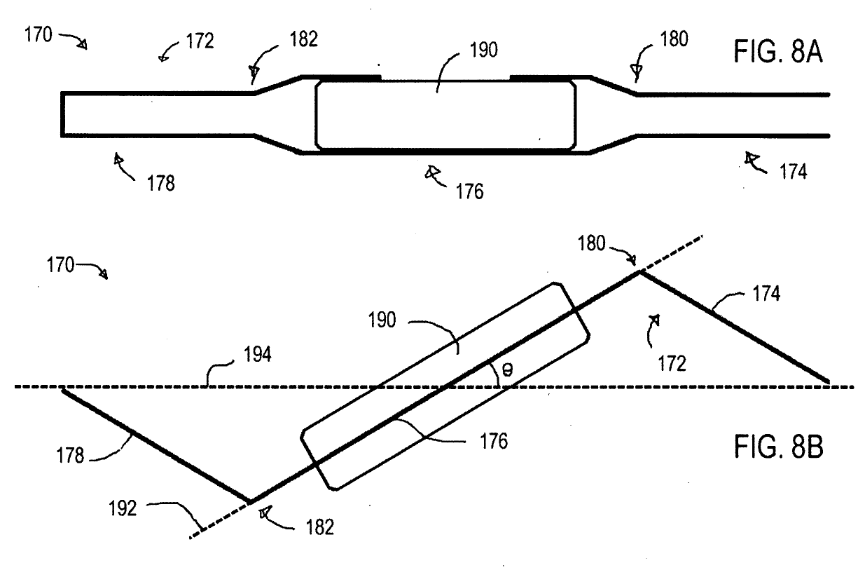

FIGS. 8A & 8B are top and side schematic views of an arc tube assembly for an HID lamp with a canted arc tube according to the present invention;

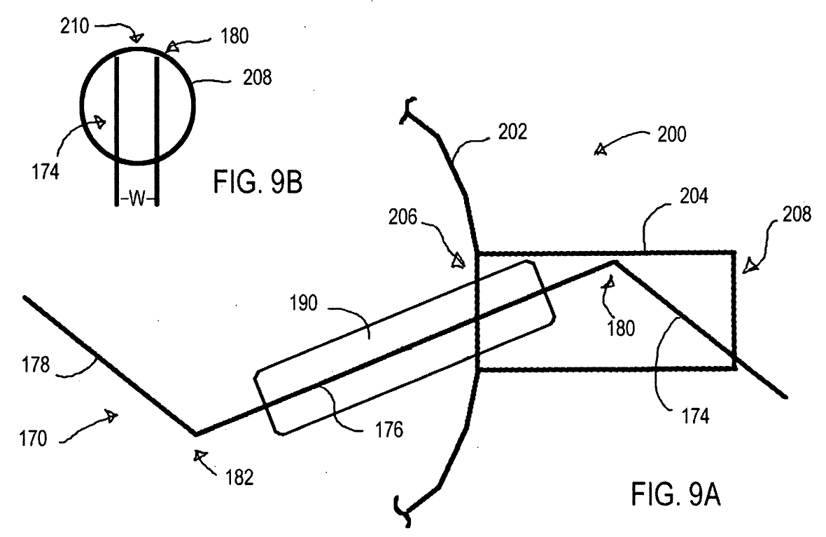

FIGS. 9A & 9B are side and end schematic views of an arc tube assembly being inserted into the neck portion of an outer envelope of an HID lamp with a canted arc tube according to the present invention;

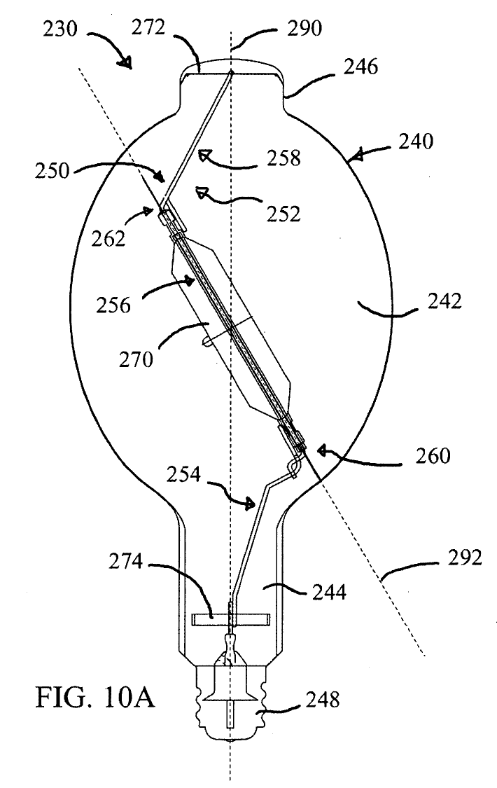

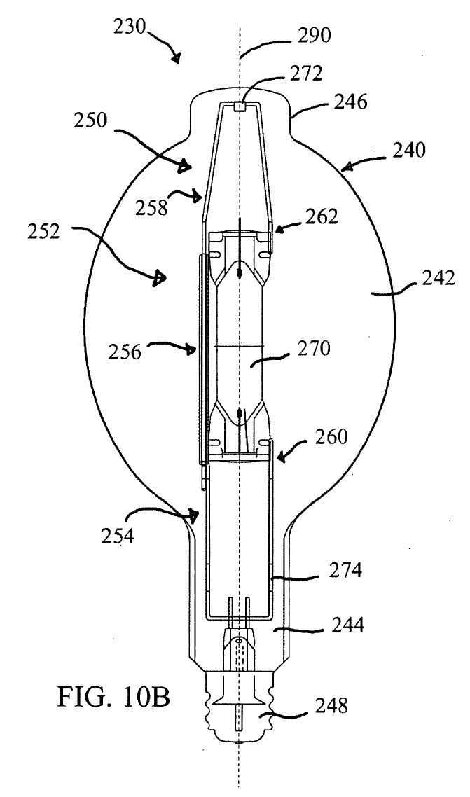

FIGS. 10A & 10B are side and top views of another HID lamp with a canted arc tube according to the present invention; and

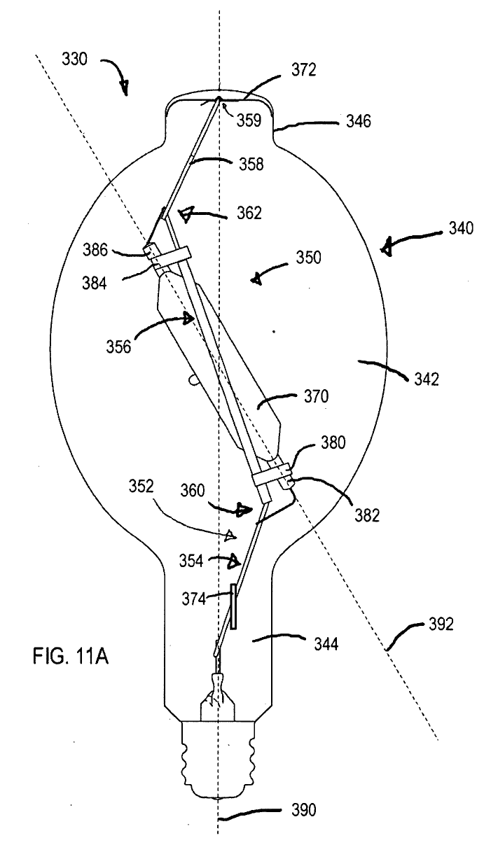

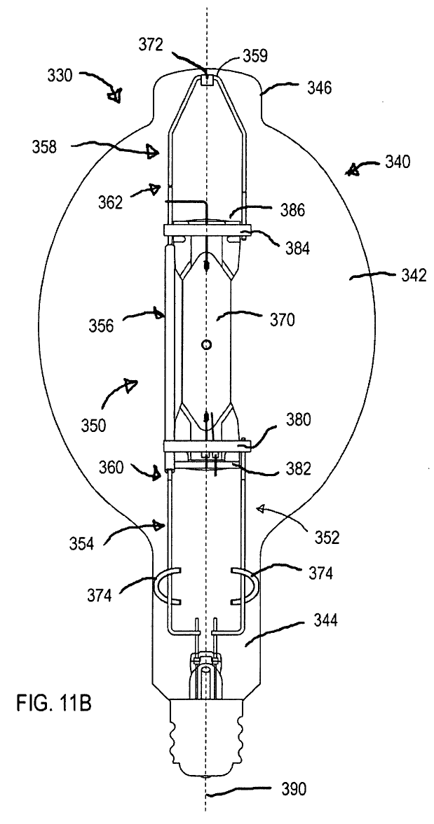

FIGS. 11A & 11B are side and top views of another HID lamp with a canted arc tube according to the present invention.

FIG. 1 is a perspective view of an HID lamp with a canted arc tube according to the present invention. In this embodiment, the HID lamp employs rotary joints as described below for FIGS. 2-4, such as one piece rotary joints, pinned rotary joints, and/or tabbed rotary joints.

Referring to FIG. 1, metal halide HID lamp 30 has a standard bulged-tube (BT) glass outer envelope 1 in which an arc tube 4, such as a metal halide arc tube, is mounted at a predetermined angle with respect to the lamp axis 32. In one example, the outer envelope 1 is a BT56 glass outer envelope and the predetermined angle is about 30 degrees. The tubular quartz arc tube 4 includes pinch seals 5 at opposite ends which seal the arc tube 4 in a gas-tight manner, discharge electrodes 6a, 6b, and a starting electrode 6c. The arc tube 4 has an arc tube axis 33. Stem 7 includes rigid current-supply conductors 13, 14 extending from the stem press and connected to current-supply wires (not shown). The pair of current-supply conductors 13, 14 are also connected to respective pair of rotary joints 20, 21. A skirt portion (not shown) of the stem 7 is sealed to the neck portion 34 of the outer envelope 1 in a gas-tight manner. The current supply wires are connected to appropriate contact portions of lamp cap 2. Frame 9 is secured to the stem 7 and holds the arc tube 4 at the predetermined angle with respect to the lamp axis 32. In one embodiment, the predetermined angle between the arc tube axis 33 and the lamp axis 32 is about 30 degrees. The frame 9 also electrically connects the current-supply conductors 13, 14 with the discharge electrodes 6a, 6b and starting electrode 6c. The arc tube 4 and the frame 9 form an arc tube assembly as defined herein. Those skilled in the art will appreciate that the current-supply conductors 13, 14 can be formed of separate lengths of wire welded together as desired for a particular application.

The frame 9 has three frame sections 9a-9c which are pivotable with respect to each other and connected with rotary joints. The rotary joints are lockable to maintain the predetermined angle between the arc tube 4 and the lamp axis 32 once the frame 9 is installed in the outer envelope 1 in the final configuration. The rotary joints are also electrically conductive. The first frame section 9a includes the current-supply conductors 13, 14. The second frame section 9b includes one rigid conductor 15b which extends along one side of the arc tube 4, an upper short conductor 16b, and a lower short conductor 16a. Each of the short conductors 16a, 16b are adjacent one of the pinch seals 5 of the arc tube 4 and are secured thereon by metallic bands 17. A quartz glass tube 18 encloses the rigid conductor 15b and electrically insulates the rigid conductor 15b from the opposing upper short conductor 16b. The first frame section 9a is pivotably connected to the second frame section 9b with the connection of the current-supply conductor 13 to the rigid conductor 15b through rotary joint 20 and the connection of the current-supply conductor 14 to the lower short conductor 16a through rotary joint 21. The third frame section 9c is a single generally U-shaped rigid wire including legs 15c, 16c connected with crossbar 36. The third frame section 9c is pivotably connected to the second frame section 9b through the pair of rotary joints 22, 23 with the connection of the leg 15c to the rigid conductor 15b through the rotary joint 22 and the connection of the leg 16c to the upper short conductor 16b through the rotary joint 23. In one embodiment, a shunt strap can be connected in parallel with one or more of the rotary joints as desired to assure current carrying capacity.

Resilient bars maintain the position of the frame 9 in the outer envelope 1. Lower resilient bars 38, 40 connected to the respective current-supply conductors 13, 14 of the first frame section 9a contact the inside surface of the neck portion 34 of the outer envelope 1. Upper resilient bars 42, 44 connected to the respective legs 15c, 16c of the third frame section 9c contact the inside surface of protruding domed portion 1c of the outer envelope 1.

The electrical connection to the arc tube 4 is provided through the frame 9 and the rotary joints. The path from the lamp cap 2 to the discharge electrode 6b includes the current-supply conductor 14 and metallic strap 8b connected to the discharge electrode 6b. The starting electrode 6c is connected to the current-supply conductor 14 through a resistor and bimetal switch (not shown). The path from the lamp cap 2 to the discharge electrode 6a includes the current-supply conductor 13, rotary joint 20, rigid conductor 15b, and metallic strap 8a connected to the discharge electrode 6a. In one embodiment, an electrical shunt (not shown) can be connected across the rotary joint 20 between the current-supply conductor 13 and the rigid conductor 15b to ensure current flow to the discharge electrode 6a.

During manufacture, the three frame sections 9a-9c of the frame 9 are aligned so that the frame 9 can pass through the neck portion 34 of the outer envelope 1. The rotary joints 20-23 allow a larger angle between frame sections than the angle in the final configuration. When the upper resilient bars 42, 44 have been placed in the domed portion 1c of the outer envelope 1, the three frame sections 9a-9c can be rotated relative to each other until the rotary joints 20-23 lock, fixing the predetermined angle between the arc tube 4 and the lamp axis 32.

FIGS. 2A-2D are exploded, bottom, side unlocked, and side locked views of a rotary joint for an HID lamp with a canted arc tube according to the present invention. The rotary joint 50, which is defined herein as a one piece rotary joint, includes a disk 52 forming a hole 54, a lock 56, and a stop 58; a connector/frame 60 forming a bend 62 with a tip 64; and a retaining washer 66. The disk 52 can be formed from a single piece. The tip 64 of the connector/frame 60 passes through the hole 54 of the disk 52 and is secured in place by the retaining washer 66, so that the connector/frame 60 can rotate about the hole 54 along the face of the disk 52 between the lock 56 and the stop 58. The connector/frame 60 is receivable in the lock 56 to lock the connector/frame 60 at the desired angle relative to connector/frame 68. The optional stop 58 limits rotation of the connector/frame 60 when the rotary joint 50 is not locked, i.e., before the connector/frame 60 is locked in the lock 56. The retaining washer 66 maintains the connector/frame 60 in electrical contact with the disk 52. The disk 52 of the rotary joint 50 can be welded to connector/frame 68. The connector/frames 60, 68 can be part of the frame of the arc tube assembly or can be a separate part that is assembled into the frame.

During manufacture of the HID lamp, the arc tube assembly is placed through the neck portion of the outer envelope with the rotary joint 50 in the unlocked configuration of FIG. 2C. The stop 58 limits the angle of rotation of the connector/frame 60, limiting the angle between the connector/frame 60 and the connector/frame 68 during installation. When the arc tube assembly is in place in the outer envelope, the connector/frames 60, 68 are rotated relative to each other until the rotary joint 50 is in the permanently locked configuration of FIG. 2D. The connector/frame 60 is held between resilient sides of the lock 56 in the locked configuration.

FIGS. 3A-3E are first part side, second part side, bottom exploded, side locked and bottom locked views of another rotary joint for an HID lamp with a canted arc tube according to the present invention. The rotary joint 70, which is defined herein as a pinned rotary joint, includes a first disk 72 forming a connection hole 74, a first alignment hole 76, and a first locking hole 78; a first connector/frame 96; a second disk 82 forming a connection cuff 84, a second alignment hole 86, and a second locking hole 88; and a second connector/frame 90 forming a bend 92 with a tip 94. The connection hole 74 of the first disk 72 is mateable with and rotatable about the connection cuff 84 of the second disk 82, allowing the first disk 72 to rotate relative to the second disk 82. The edge of the connection cuff 84 can be rolled to retain the first disk 72 on the second disk 82. The second connector/frame 90 is connected to the second disk 82 so that the tip 94 of the second connector/frame 90 passes through the second locking hole 88. The second connector/frame 90 is attached to the second disk 82 so that the resilience of the second connector/frame 90 and/or the second disk 82 urges the tip 94 through the second locking hole 88 toward the first disk 72. When the rotary joint 70 is in the locked configuration, the second locking hole 88 is aligned with the first locking hole 78, so the tip 94 passes through both the second locking hole 88 and the first locking hole 78 to prevent rotation of the first disk 72 relative to the second disk 82. The first disk 72 can be welded to the first connector/frame 96. The first connector/frame 96 and the second connector/frame 90 can be part of the frame of the arc tube assembly or can be a separate part that is assembled into the frame.

During manufacture of the HID lamp, the arc tube assembly is placed through the neck portion of the outer envelope with the rotary joint 70 in the unlocked configuration and rotated into the locked configuration of FIGS. 3D & 3E. The first alignment hole 76 of the first disk 72 and the second alignment hole 86 of the second disk 82 are initially aligned to indicate the proper angle between the first connector/frame 96 and the second connector/frame 90 during installation. When the arc tube assembly is in place in the outer envelope, the first connector/frame 96 and the second connector/frame 90 are rotated relative to each other until the first locking hole 78 and the second locking hole 88 are aligned, so that the tip 94 of the second connector/frame 90 passes through both the second locking hole 88 and the first locking hole 78. This places the rotary joint 70 in a permanently locked configuration.

Those skilled in the art will appreciate that the first disk 72 and the second disk 82 can form additional locking holes as desired for a particular application. The additional locking holes can be located across the connection hole 74 from the first locking hole 78 and the second locking hole 88. The first connector/frame 96 is bent to form a tip which passes through the additional locking holes when the additional locking holes are aligned, further locking the rotary joint 70 in the permanently locked configuration in addition to the locking provided by the tip 94, the second locking hole 88, and the first locking hole 78.

FIG. 4A-4F are first part side, first part bottom, second part side, second part bottom, side unlocked, and side locked views of another rotary joint for an HID lamp with a canted arc tube according to the present invention. The rotary joint 100, which is defined herein as a tabbed rotary joint, includes a first disk 102 forming a connection hole 104, an alignment tab 106, and an opposed tab pair 108; a first connector/frame 126; a second disk 112 forming a connection cuff 114, an alignment hole 116, and a hole pair 118; and a second connector/frame 120. The connection hole 104 of the first disk 102 is mateable with and rotatable about the connection cuff 114 of the second disk 112, allowing the first disk 102 to rotate relative to the second disk 112. The edge of the connection cuff 114 can be rolled to retain the first disk 102 on the second disk 112. The first connector/frame 126 and the second connector/frame 120 can be connected to the first disk 102 and the second disk 112, respectively. The first connector/frame 126 and the second connector/frame 120 can be part of the frame of the arc tube assembly or can be a separate part that is assembled into the frame. When the rotary joint 100 is in the unlocked configuration, the optional alignment tab 106 of the first disk 102 can spring into the optional alignment hole 116 of the second disk 112, limiting the rotation of the first disk 102 relative to the second disk 112 when the alignment tab 106 is aligned with the alignment hole 116. When the rotary joint 100 is in the locked configuration, the opposed tab pair 108 of the first disk 102 can spring into the hole pair 118 of the second disk 112. The rotary joint 100 locks because the two tabs of the opposed tab pair 108 are directed toward each other in opposed directions and mateable with the hole pair 118, so that each tab prevents rotation in one direction, i.e., one prevents clockwise rotation and the other prevents counterclockwise rotation when the opposed tab pair 108 is aligned with the hole pair 118.

During manufacture of the HID lamp, the arc tube assembly is placed through the neck portion of the outer envelope with the rotary joint 100 in the unlocked configuration of FIG. 4E and rotated into the locked configuration of FIG. 4F. The alignment tab 106 is initially seated in the alignment hole 116 to assure the proper angle between the first connector/frame 126 and the second connector/frame 120 during installation. When the arc tube assembly is in place in the outer envelope, the first connector/frame 126 and the second connector/frame 120 are rotated relative to each other until the opposed tab pair 108 seats in the hole pair 118. This places the rotary joint 100 in a permanently locked configuration.

Those skilled in the art will appreciate that the rotary joints described above in FIGS. 2-4 above can be modified as desired for a particular application. For example, different angles for the connector/frames in the locked and unlocked configuration and between the connector/frames can be desirable for different applications. The relative positions of the components determining the angle in the unlocked configuration and the locked configuration can be selected as desired, such as the relative position of the lock and stop of the one piece rotary joint; the alignment holes and locking holes of the pinned rotary joint; and the alignment tab, opposed tab pair, alignment hole, and hole pair of the tabbed rotary joint. In another example, a shunt strap can be connected in parallel with one or more of the rotary joints as desired to assure current carrying capacity.

FIG. 5, in which like elements share like reference numbers with FIG. 1, is a perspective view of another HID lamp with a canted arc tube according to the present invention. In this embodiment, the HID lamp employs a first connection including one rotary joint and one deformable connector to connect the first frame section to the second frame section and a second connection including one rotary joint and one deformable connector to connect the second frame section to the third frame section. The rotary joints can be one piece rotary joints, pinned rotary joints, and/or tabbed rotary joints as described above for FIGS. 2-4 or single slotted rotary joints and/or double slotted rotary joints as described below for FIGS. 6 & 7. In one embodiment, only one of the first connection or the second connection has a rotary joint and a deformable connector and the other connection has a different configuration, such as two rotary joints or two deformable connectors.

Referring to FIG. 5, the first frame section 9a of the HID lamp 430 is pivotably connected to the second frame section 9b with the connection of the current-supply conductor 13 to the rigid conductor 15b through deformable connector 130 and the connection of the current-supply conductor 14 to the lower short conductor 16a through rotary joint 21. The third frame section 9c is pivotably connected to the second frame section 9b with the connection of the leg 15c to the rigid conductor 15b through deformable connector 132 and the connection of the leg 16c to the upper short conductor 16b through rotary joint 23. The deformable connectors 130, 132 can be a bendable portion of the frame 9 made of an electrically conductive soft metal, such as aluminum, tantalum, nickel, alloys thereof, or the like. In one embodiment, the deformable connectors 130, 132 can be thinner that the frame section in which the deformable connectors are installed to assure that the deformable connector bends rather than the frame. Those skilled in the art will appreciate that the position of the rotary joint and the deformable connector joining a pair of frame sections can be reversed as desired for a particular application, e.g., the rotary joint connecting the first frame section 9a to the second frame section 9b could be connected to the current-supply conductor 13 or the current-supply conductor 14. In one embodiment, the rotary joints connect portions of the frame which do not carry current to assure that no shunt strap is required across the rotary joint. In another embodiment, a shunt strap is electrically connected in parallel with the rotary joint 21, 23.

During manufacture, the three frame sections 9a-9c of the frame 9 are aligned so that the frame 9 can pass through the neck portion 34 of the outer envelope 1. The rotary joints 21, 23 and the deformable connectors 130, 132 allow a larger angle between frame sections than the angle in the final configuration. When the upper resilient bars 42, 44 have been placed in the domed portion 1c of the outer envelope 1, the three frame sections 9a-9c can be rotated relative to each other to lock the rotary joints 21, 23 and bend the deformable connectors 130, 132, fixing the predetermined angle between the arc tube 4 and the lamp axis 32.

FIG. 6 is an exploded view of another rotary joint for an HID lamp with a canted arc tube according to the present invention. The rotary joint can be used as described above for FIG. 5. Referring to FIG. 6, the rotary joint 138, which is defined herein as a double slotted rotary joint, includes two thin metallic disks 140, 141. The disk 141 has a central aperture with a cuff 146 which extends through aperture 147 in disk 140 and is rolled outwards to secure the two disks together and to permit relative rotation of the two disks 140, 141. The cuff 146 can be formed by piercing and extruding the disk 140 to form a flanged hole. The disk 141 has two diametrically opposite slots 143 and disk 140 has two diametrically opposite tabs 144 bent out of the plane of the disk 140. The tabs 144 and slots 143 pivot and lock the two disks 140, 141 during lamp assembly. Each disk 140, 141 also has a straight cupped portion 145 extending therefrom which matches the contour of the joined frame conductors to permit an easier and more secure weld.

FIG. 7 is an exploded view of another rotary joint for an HID lamp with a canted arc tube according to the present invention. The rotary joint can be used as described above for FIG. 5. Referring to FIG. 7, the rotary joint 148, which is defined herein as a single slotted rotary joint, includes two thin metallic disks 150, 151. The disks 150, 151 can be secured together with a rivet 156 to permit relative rotation. The disk 151 has a slot 153 and disk 150 has a tab 154 bent out of the plane of the disk 150. The tab 154 and slot 153 pivot and lock the two disks 150, 151 during lamp assembly. In this embodiment, the disks 150, 151 are welded to the frame section without a cupped portion.

FIGS. 8A & 8B are top and side schematic views of an arc tube assembly for an HID lamp with a canted arc tube according to the present invention. In this embodiment, the arc tube assembly employs a fixed frame without rotary joints or bendable portions. The arc tube assembly is so dimensioned as to be insertable through the neck portion of an outer envelope.

The arc tube assembly 170 includes a fixed frame 172 and an arc tube 190. The fixed frame 172 has a first frame section 174, a second frame section 176, and a third frame section 178, with a first bend 180 between the first frame section 174 and the second frame section 176, and a second bend 182 between the second frame section 176 and the third frame section 178. The arc tube 190 is attached to the fixed frame 172 between the first bend 180 and the second bend 182. The first bend 180 is opposite the second bend 182, i.e., the first bend 180 and the second bend 182 open in opposite directions. In this embodiment, the first bend 180 and the second bend 182 are the clearance points which contact the inside of the neck portion of the outer envelope when the arc tube assembly 170 is inserted through the neck portion. Clearance points as defined herein are the points of the arc tube assembly which contact the inside of the neck portion of the outer envelope when the arc tube assembly is inserted through the neck portion. The arc tube assembly 170 is narrow at the clearance points so that the arc tube assembly 170 has room to rotate through the neck portion. The arc tube 190 has an arc tube axis 192, which forms a predetermined angle θ to the lamp axis 194 when the fixed frame 172 is in a final configuration in the outer envelope. In one example, the predetermined angle is about 30 degrees.

FIGS. 9A & 9B, in which like elements share like reference numbers with FIGS. 8A & 8B, are side and end schematic views of an arc tube assembly being inserted into the neck portion of an outer envelope of an HID lamp with a canted arc tube according to the present invention. In this example, the first bend is the clearance point as the arc tube assembly is being rotated through the neck portion of the outer envelope.

Referring to FIG. 9A, the arc tube assembly 170 has been partially inserted into the outer envelope 200, which includes a globe portion 202 and a neck portion 204. The neck portion 204 has a neck entrance 208 and a neck exit 206. The outer envelope 200 can also include a flared portion (not shown) at the neck entrance 208 which can be present when the arc tube assembly is being placed within the outer envelope 200 and then removed or remodeled for fitting of a lamp cap. The arc tube 190 and second frame section 176 are passing through the neck exit 206 with the arc tube 190 in contact with the lower edge of the neck exit 206. The first frame section 174 is passing through the neck entrance 208 with the first frame section 174 in contact with the lower edge of the neck entrance 208. The first bend 180 is the clearance point and is in contact with the inside of the upper portion of the neck portion 204. The clearance point moves along the upper portion of the neck portion 204 toward the neck exit 206 as the arc tube assembly 170 is inserted.

Referring to FIG. 9B, the first bend 180, i.e., the clearance point, is able to be near the upper portion 210 of the neck portion 204 because of the narrowness of the width W of the first frame section 174. The narrower the width W, the closer the first bend 180 to the upper portion 210, which provides more room to maneuver the arc tube assembly 170 through the neck portion 204 and/or the opportunity to design the first bend 180 to be more acute.

Those skilled in the art will appreciate that the dimensions of the arc tube assembly can be selected to suit a particular application, so that the arc tube assembly is insertable through the neck portion of the outer envelope. The narrower the clearance point in contact with the inside of the neck portion when the arc tube assembly is being rotated through the neck portion, the more acute the bend can be. Similarly, the narrower the portion of the fixed frame and/or arc tube in contact with the neck entrance or neck exit when the arc tube assembly is being rotated through the neck portion, the more acute the bend can be. In one embodiment, the bend is offset from the arc tube axis, so that the arc tube pinch seal is the clearance point. In another embodiment, the first frame section and/or third frame section include curves and/or steps to allow more room between the frame section and the neck entrance or neck exit when the arc tube assembly is being rotated through the neck portion.

FIGS. 10A & 10B are side and top views of another HID lamp with a canted arc tube according to the present invention. In this embodiment, the fixed frame of the arc tube assembly is so dimensioned as to be insertable through the neck portion of the outer envelope. A bend in the fixed frame is the clearance point that contacts the inside of the neck portion when the fixed frame is inserted through the neck portion during installation of the arc tube assembly.

The HID lamp 230 includes an outer envelope 240 and an arc tube assembly 250 located within the outer envelope 240. The outer envelope 240 having a lamp axis 290 includes a globe portion 242, a neck portion 244, and a domed portion 246. A lamp cap 248 provides the electrical connection to the HID lamp 230. The arc tube assembly 250 includes a fixed frame 252, and an arc tube 270 having an arc tube axis 292. The fixed frame 252 has a first frame section 254, a second frame section 256, and a third frame section 258, with a first bend 260 between the first frame section 254 and the second frame section 256, and a second bend 262 between the second frame section 256 and the third frame section 258. In this example, the second frame section 256 is enclosed in an insulating tube. The first frame section 254 includes a number of steps to allow the rigid arc tube assembly 250 to pass through the neck portion 244 and achieve the desired angle with the lamp axis 290. Those skilled in the art will appreciate that the first frame section 254 and/or the third frame section 258 can include steps and/or curves to increase the maneuverability of the fixed frame 252 through the neck portion 244, as long as the angle between the arc tube axis 292 and the lamp axis 290 is the desired predetermined angle. In one embodiment, the predetermined angle between the arc tube axis 292 and the lamp axis 290 in the final configuration of the HID lamp 230 is about 30 degrees. A leaf spring 272 fixed to or pivotably attached about the third frame section 258 maintains the position of the arc tube assembly 250 in the domed portion 246. Leaf springs 274 attached to the first frame section 254 maintain the position of the arc tube assembly 250 in the neck portion 244.

In this embodiment, one or both of the first bend 260 and the second bend 262 are the clearance points during installation of the arc tube assembly 250 in the outer envelope 240. The second frame section 256 is longer than the arc tube 270, so the first bend 260 and the second bend 262 extend beyond the arc tube 270. The widths of the first bend 260 and the second bend 262 are selected so the fixed frame 252 is insertable through the neck portion 244. Those skilled in the art will appreciate that the one or both of the first bend 260 and the second bend 262 can be rigid to maintain a constant angle when inserted through the neck portion 244, i.e., the angle of the bend remains constant and does not increase or decrease. In another embodiment, one or both of the first bend 260 and the second bend 262 can be resilient, so that the angle of the bend changes slightly, such as increasing or decreasing, when passing through the neck portion 244 and returns to the original bend angle once inside the outer envelope 240.

FIGS. 11A & 11B are side and top views of another HID lamp with a canted arc tube according to the present invention. In this embodiment, the fixed frame of the arc tube assembly is so dimensioned as to be insertable through the neck portion of the outer envelope. The pinch seal of the arc tube is the clearance point that contacts the inside of the neck portion when the fixed frame is inserted through the neck portion during installation of the arc tube assembly.

The HID lamp 330 includes an outer envelope 340 and an arc tube assembly 350 located within the outer envelope 340. The outer envelope 340 includes a globe portion 342, a neck portion 344, and a domed portion 346. The arc tube assembly 350 includes a fixed frame 352 and an arc tube 370. The fixed frame 352 has a first frame section 354, a second frame section 356, and a third frame section 358, with a first bend 360 between the first frame section 354 and the second frame section 356, and a second bend 362 between the second frame section 356 and the third frame section 358. In one embodiment, the predetermined angle between the arc tube axis 392 and the lamp axis 390 in the final configuration of the HID lamp 330 is about 30 degrees. In this example, the second frame section 356 is enclosed in an insulating tube and is at a desired angle to the arc tube axis 392. Angling the second frame section 356 off the arc tube axis 392 can be used to reduce shadowing of the arc tube 370 by the second frame section 356.

A leaf spring 372 attached to the third frame section 358 is receivable in and maintains the position of the arc tube assembly 350 in the domed portion 346. The leaf spring 372 is pivotably attached about the end portion 359 of the third frame section 358 so that the leaf spring 372 can follow the contour of the interior of the outer envelope 340 as the leaf spring 372 enters the globe portion 342 from the neck portion 344 of the outer envelope 340 when the arc tube assembly 350 is being inserted into the outer envelope 340. U-shaped springs 374 attached to the first frame section 354 of the fixed frame 352 maintain the position of the arc tube assembly 350 in the neck portion 344. The U-shaped springs 374 can be aligned to spring against the neck portion 344. The arc tube 370 includes a first pinch seal 382 near the first bend 360 and a second pinch seal 386 near the second bend 362. The arc tube 370 is attached to the fixed frame 352 with metallic bands 380, 384.

In this embodiment, the bends 360, 362 are located off the arc lamp axis 392, so one or both of the pinch seals 382, 386 at the ends of the arc tube 370 are the clearance points during installation of the arc tube assembly 350 in the outer envelope 340. The bends 360, 362 are nearer the lamp axis 390 than their respective pinch seals 382, 386. The widths of the pinch seals 382, 386 determine the dimensions of the fixed frame 352 that can be inserted through the neck portion 344.

Those skilled in the art will appreciate that the arc tube assembly can optionally be flexible and/or include flexible portions as desired for a particular purpose. In one example, one or more of the bends in the fixed frame can be resilient so the angle of the bend opens while the bend is the clearance point passing through the neck portion of the outer envelope. In another example, the one or more of the frame sections can be resilient so arc tube assembly becomes flatter, i.e., more linear, as the frame section passes through the neck portion of the outer envelope. Lubricants and/or coatings can also be applied to the outer envelope and/or the arc tube assembly so that the arc tube assembly slides more easily through the neck portion. In one example, the interior of the outer envelope can be coated with AP-5 glass coating.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A high intensity discharge (HID) lamp comprising:
an outer envelope (1) having a neck portion (34) and a lamp axis (32);
a frame (9) having a first frame section (9a), a second frame section (9b), a third frame section (9c), the first frame section (9a) being pivotably connected to the second frame section (9b) in a first connection, and the second frame section (9b) being pivotably connected to the third frame section (9c) in a second connection; and
an arc tube (4) having an arc tube axis (33), the arc tube (4) being attached to the second frame section (9b);
wherein at least one of the first connection and the second connection is a deformable connector (130, 132) paired with a rotary joint (21, 23); and
the arc tube axis (33) forms a predetermined angle with the lamp axis (32) when the frame (9) is in a final configuration in the outer envelope (1).

2. The HID lamp of claim 1 wherein the rotary joint (21, 23) is a one piece rotary joint comprising:
a disk (52) forming a hole (54) and a lock (56);
a connector/frame (60) forming a bend (62) with a tip (64); and
a retaining washer (66);
wherein the tip (64) of the connector/frame (60) passes through the hole (54) and is rotatably secured by the retaining washer (66), and the connector/frame (60) is receivable in the lock (56).

3. The HID lamp of claim 2 wherein the disk (52) further forms a stop (58), the stop (58) limiting rotation of the connector/frame (60).

4. The HID lamp of claim 1 wherein the rotary joint (21, 23) is a pinned rotary joint comprising:
a first disk (72) forming a connection hole (74) and a first locking hole (78);
a second disk (82) forming a connection cuff (84) and a second locking hole (88); and
a connector/frame (90) forming a bend (92) with a tip (94);
wherein the connection hole (74) is mateable with and rotatable about the connection cuff (84);
the tip (94) passes through the second locking hole (88) and is urged toward the first disk (72) so that the tip (94) passes through the second locking hole (88) and the first locking hole (78) when the second locking hole (88) and the first locking hole (78) are aligned.

5. The HID lamp of claim 1 wherein the rotary joint (21, 23) is a tabbed rotary joint comprising:
a first disk (102) forming a connection hole (104) and an opposed tab pair (108); and
a second disk (112) forming a connection cuff (114) and a hole pair (118);
wherein the connection hole (104) is mateable with and rotatable about the connection cuff (114); and
tabs of the opposed tab pair (108) are oriented in opposed directions and mateable with the hole pair (118) to lock the first disk (102) relative to the second disk (112) when the opposed tab pair (108) is aligned with the hole pair (118).

6. The HID lamp of claim 5 wherein the first disk (102) forms an alignment tab (106) and the second disk (112) forms an alignment hole (116), the alignment tab (106) being mateable with the alignment hole (116) to limit rotation when the alignment tab (106) is aligned with the alignment hole (116).

7. The HID lamp of claim 1 wherein the rotary joint (21, 23) is selected from the group consisting of a single slotted rotary joint (148) and a double slotted rotary joint (138).

8. The HID lamp of claim 1 wherein the deformable connector (130, 132) is made of an electrically conductive soft metal selected from the group consisting of aluminum, tantalum, nickel, and alloys thereof.

9. The HID lamp of claim 1 wherein the first connection is a first deformable connector (130) paired with a first rotary joint (21) and the second connection is a second deformable connector (132) paired with a second rotary joint (23).

10. The HID lamp of claim 1 further comprising a shunt strap electrically connected in parallel with the rotary joint (21, 23).

11. The HID lamp of claim 1 wherein the predetermined angle is about 30 degrees.

12. A high intensity discharge (HID) lamp comprising:
an outer envelope (1) having a neck portion (34) and a lamp axis (32);
a frame (9) having a first frame section (9a), a second frame section (9b), a third frame section (9c), a first pair of rotary joints (20, 21) pivotably connecting the first frame section (9a) and the second frame section (9b), a second pair of rotary joints (22, 23) pivotably connecting the second frame section (9b) and the third frame section (9c); and
an arc tube (4) having an arc tube axis (33), the arc tube (4) being attached to the frame (9) between the first pair of rotary joints (20, 21) and the second pair of rotary joints (22, 23);
wherein the first pair of rotary joints (20, 21) and the second pair of rotary joints (22, 23) are selected from the group consisting of one piece rotary joints, pinned rotary joints, and tabbed rotary joints; and
the arc tube axis (33) forms a predetermined angle with the lamp axis (32) when the frame (9) is in a final configuration in the outer envelope (1).

13. The HID lamp of claim 12 further comprising a shunt strap electrically connected in parallel with at least one rotary joint selected from the first pair of rotary joints (20, 21) and the second pair of rotary joints (22, 23).

14. The HID lamp of claim 12 wherein the predetermined angle is about 30 degrees.

15. A high intensity discharge (HID) lamp comprising:
an outer envelope (240) having a neck portion (244) and a lamp axis (290);
a fixed frame (252) having a first bend (260) and a second bend (262) opposite the first bend (260); and
an arc tube (270) having an arc tube axis (292), the arc tube (270) being attached to the fixed frame (252) between the first bend (260) and the second bend (262);
wherein the fixed frame (252) is so dimensioned as to be insertable through the neck portion (244); and
the arc tube axis (292) forms a predetermined angle with the lamp axis (290) when the fixed frame (252) is in a final configuration in the outer envelope (240).

16. The HID lamp of claim 15 wherein at least one of the first bend (260) and the second bend (262) maintain a constant angle when inserted through the neck portion.

17. The HID lamp of claim 15 wherein both the first bend (260) and the second bend (262) maintain a constant angle when inserted through the neck portion (244).

18. The HID lamp of claim 15 at least one of the first bend (260) and the second bend (262) changes angle when inserted through the neck portion (244).

19. The HID lamp of claim 15 wherein at least one of the first bend (260) and the second bend (262) is a clearance point when the fixed frame (252) is inserted through the neck portion (244).

20. The HID lamp of claim 15 wherein the arc tube has a pinch seal and the pinch seal is a clearance point when the fixed frame is inserted through the neck portion.

21. The HID lamp of claim 15 wherein the arc tube has a first pinch seal and a second pinch seal, the first bend is nearer the lamp axis than the first pinch seal, and the second bend is nearer the lamp axis than the second pinch seal.

22. The HID lamp of claim 15 wherein the fixed frame (252) includes steps.

23. The HID lamp of claim 15 wherein the fixed frame has a second frame section between the first bend and the second bend, wherein the second frame section is angled off the arc tube axis.

24. The HID lamp of claim 15 wherein the outer envelope has a domed portion, the fixed frame has an end portion, and further comprising a leaf spring pivotably attached about the end portion and receivable in the domed portion.

25. The HID lamp of claim 15 further comprising U-shaped springs attached to the fixed frame and aligned to spring against the neck portion.

26. The HID lamp of claim 15 wherein the predetermined angle is about 30 degrees.
